(19) United States
(12) Patent Application Publication
(10) Pub. No.: US 2016/0213564 A1
(43) Pub. Date: Jul. 28, 2016

(54) METHOD OF MASSAGING USING A MASSAGE TOOL

(71) Applicant: Jonathan Thorn, Castro Valley, CA (US)

(72) Inventor: Jonathan Thorn, Castro Valley, CA (US)

(21) Appl. No.: 14/606,906

(22) Filed: Jan. 27, 2015

(51) Int. Cl. A61H 39/04

(52) U.S. Cl. CPC A61H 39/04

(57) ABSTRACT

A method of massaging is provided that allows a user to use a massage tool to selectively apply pressure to an arm or leg. The massage tool includes a body having a curved surface, a strap and a handle. In the method, the strap is placed around the arm or leg, the strap is tightened, and a handle attached to the tool is moved. As a result of this method, the force of the curved surface of the tool may be accurately adjusted to provide for the release of tension in specific muscles.

### BACKGROUND OF THE INVENTION

1. Field of the Invention

The present invention generally relates to a device and method of massaging, and more particularly to a device and method that person may use to massage their muscles.

2. Discussion of the Background

Massage is typically performed by applying pressure to the body of a patient, either manually or using a massage tool. Massage tools typically include some manner of surface or feature that is designed to contact the patient's body for the purpose of manipulating the patient's muscle tissue or connective tissue.

It is common for people to massage their own arms or legs to release tension in the muscles. When massaging one's own body, however, such as by applying pressure to one's own soft tissue, it is difficult to apply pressure to a trigger point (i.e. a muscle knot) without tensing the muscles.

A vast array of massage tools have been used in the past. Many previously-used tools are awkward to hold and thus difficult to use. In addition, such tools do not resolve the problem of the user tensing their own muscles to use the tools, and thus they are not as effective as they might be.

There is a need for a massage tool that is easy to manipulate, comfortable to hold, and which is versatile. There is also a need for a massage tool that a user may use to apply forces more selectively to specific parts of the body by pinpointing pressure and massage target areas with a minimal amount of effort by the user.

### BRIEF SUMMARY OF THE INVENTION

The present invention overcomes the disadvantages of prior art by providing a method that allows a user to accurately apply a force to the body.

Certain aspects provide a method for massaging a user with a device that includes a handle, body including a surface, a strap, and a mechanism for adjusting the length of the strap. The method includes: placing the user between the body of the device and the strap, such that the strap and the body of the device surrounds the user; adjusting the length of the strip such that the surface is held against the user; and moving the handle to increase the force of the surface on the user.

Certain other aspects provide a method for massaging a user with a device that includes a handle, a body including a surface, a strap, and a mechanism for adjusting the length of the strap. The method includes: inserting the user between the surface and the strap, such that the strap and surface surrounds the user; pulling the end of the strap to tighten the strap and surface against the user; and moving the handle in a plane perpendicular to the user, such that the force on the user is adjusted.

These features together with the various ancillary provisions and features which will become apparent to those skilled in the art from the following detailed description, are attained by the method of massaging of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a front, side perspective view of a first embodiment device for massaging;

FIG. 2 is a back, side perspective view of the device of FIG. 1;

FIG. 3 is a side view of the device of FIG. 1;

FIG. 4 is a sectional view 4-4 of FIG. 1;

FIGS. 5A, 5B, and 5C are front views of a method of using the device of FIG. 1, where FIG. 5A illustrates the positioning of the device on the user; FIG. 5B illustrates the tightening of the device on the user; and FIG. 5C illustrates the user of the device is massaging the user;

FIG. 6 is a back, side perspective view of a second embodiment device for massaging; and

FIG. 7 is a side view of the device of FIG. 6.

Reference symbols are used in the Figures to indicate certain components, aspects or features shown therein, with reference symbols common to more than one Figure indicating like components, aspects or features shown therein.

### DETAILED DESCRIPTION OF THE INVENTION

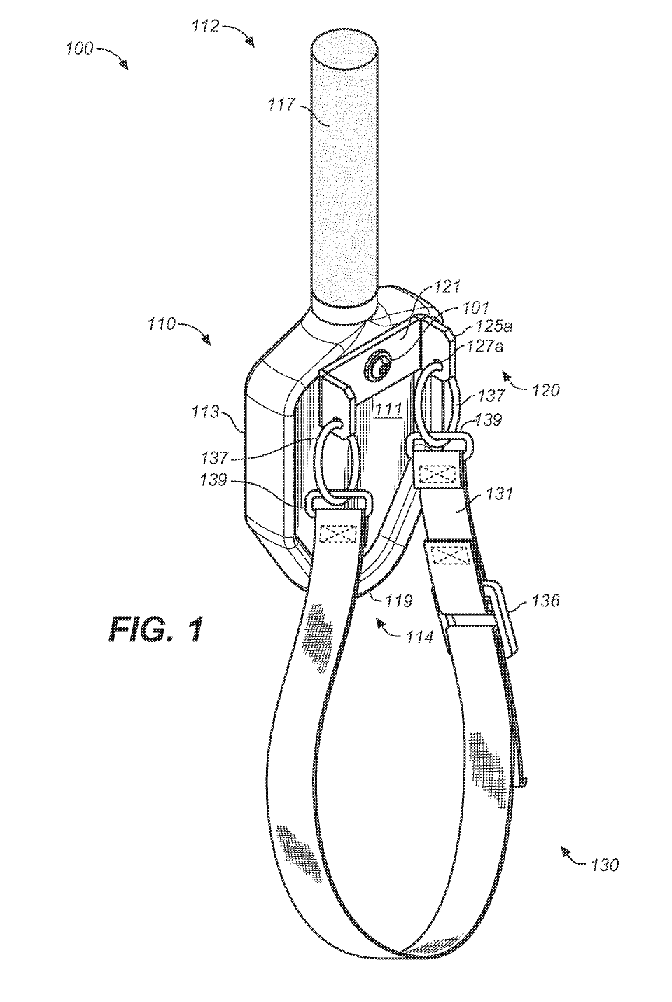

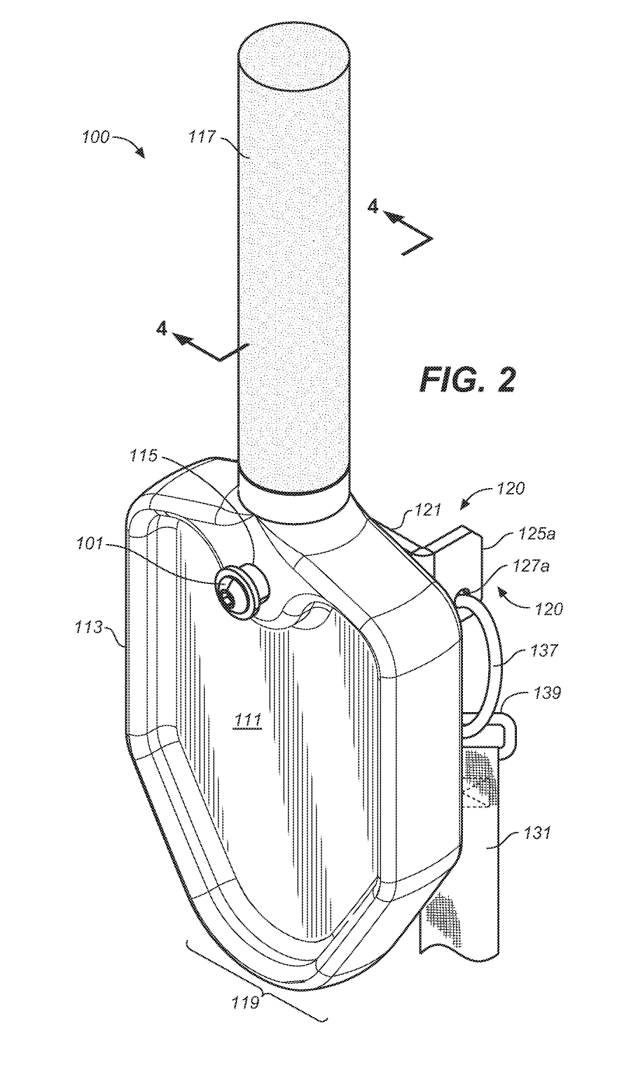

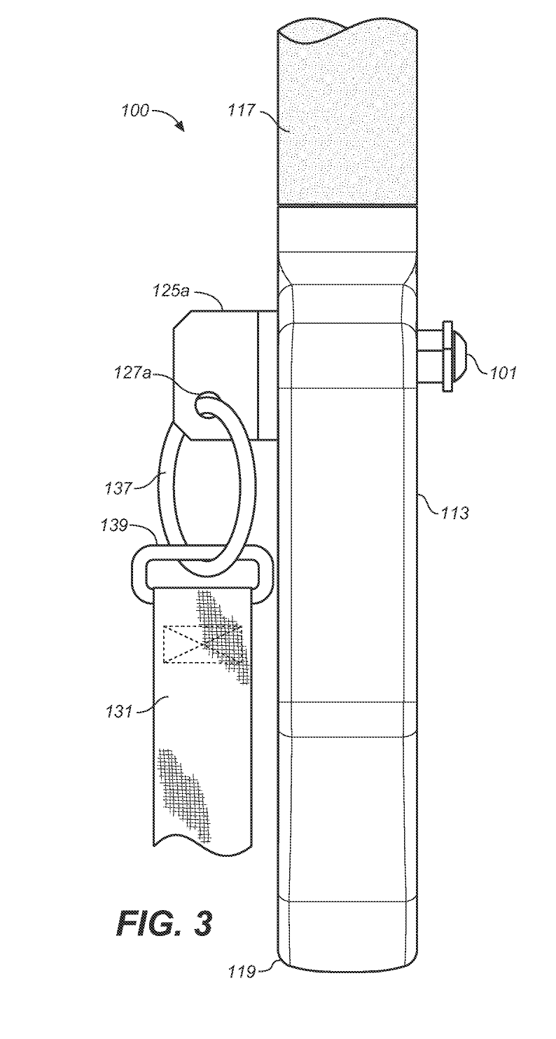

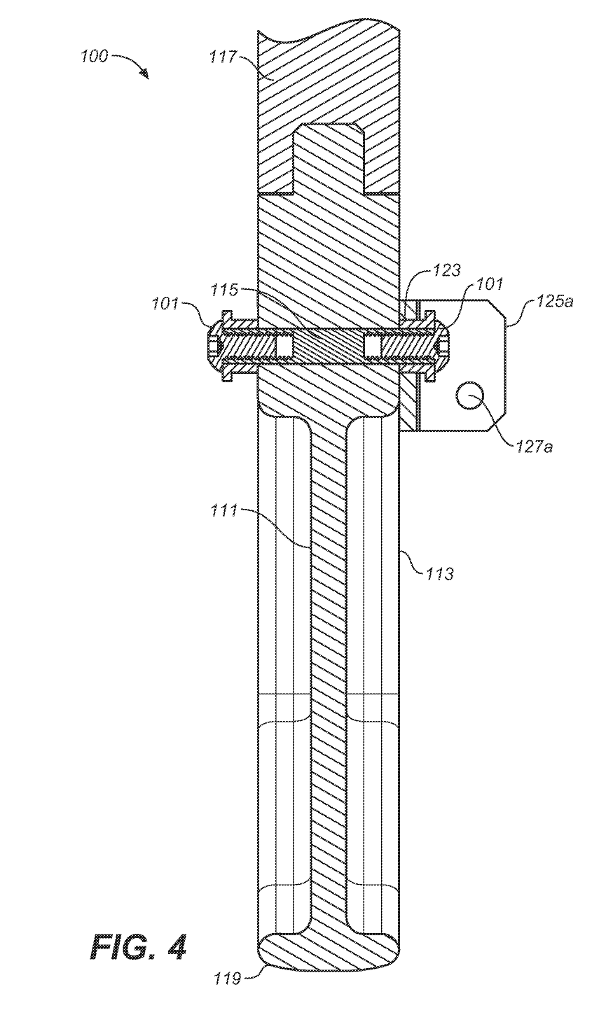

The present invention allows a user to massage a muscle or location on their body with a desired force. A first embodiment of the device 100 is shown in FIGS. 1-4, where FIG. 1 is a front, side perspective view of the device, FIG. 2 is a back, side perspective view of the device, FIG. 3 is a side view of the device; FIG. 4 is a sectional view 4-4 of FIG. 1.

In one embodiment, device 100 includes a body 110, a bracket 120, and a restraining portion 130. Body 110, which has a proximal end 112 and a distal end 114, includes a plate 111 surrounded by a flange 113, and also includes a handle 117 at the proximal end and a curved surface 119 of the flange at distal end 114, which is best seen in FIG. 2.

Bracket 120 includes a flat portion 121, and a pair of flanges 125a, 125b each having corresponding holes 127a, 127b. In general, body 110 and bracket 120 are formed or joined together. FIGS. 1-4 illustrate one method of securing body 110 and bracket 120, where, as is shown most clearly in FIG. 4, the bracket is attached to the body by a bolt 101 that passes through a hole 123 in flat portion 121 and a hole 115 in flange 113.

Restraining portion 130 includes a strap 131 having a free end 134, pairs of interlocking rings 137 and 139 that attach the strap to holes 127a and 127b, and a buckle 136 that accepts the free end. Restraining portion 130 is thus attached to bracket 120 and has a length between holes 127a and 127b that may be adjusted by pulling or releasing free end 134.

In one embodiment, flange 113 and plate 111 are formed together by injection molding a plastic, such as Nylon or ABS. Handle 117 may also be injection molded with flange 113 and plate 111, or may be a separate piece that is attached to flange 113 by an adhesive or by otherwise fastening the parts together. In another embodiment, bracket 120 is formed from sheet metal, such as Aluminum or Steel or an injection molded plastic material, such as Nylon, ABS, or Polycarbonate. In other embodiments, strap 131 is formed from lengths of webbing, and buckle 136 is a strap adjuster buckle which is commonly used for adjusting the length of webbing straps.

In one embodiment, the width of the strap and the flange are approximately the same, and are 2 inches. In another embodiment, the length of strap 131 between rings 139 is from 36 inches to 48 inches. In yet another embodiment, the distance between proximal end 112 and distal end 113 of body 110 is from 9 inches to 12 inches.

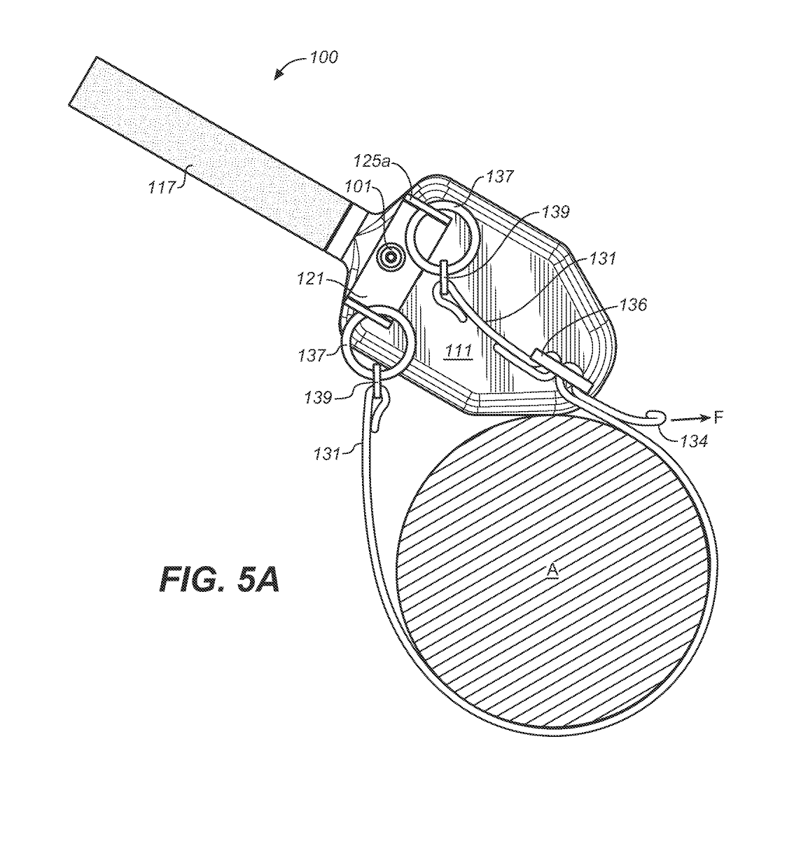

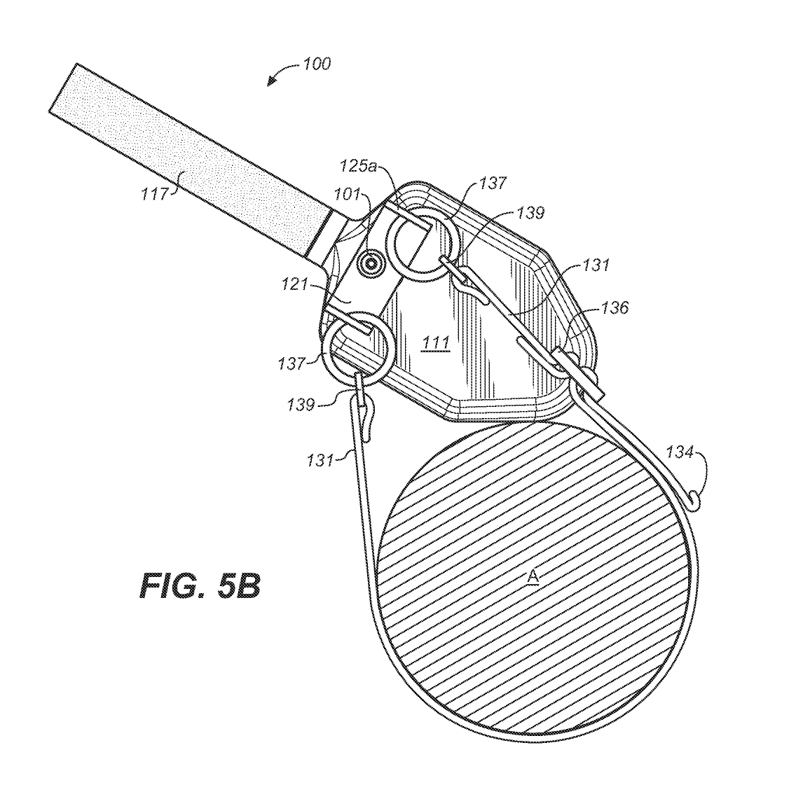

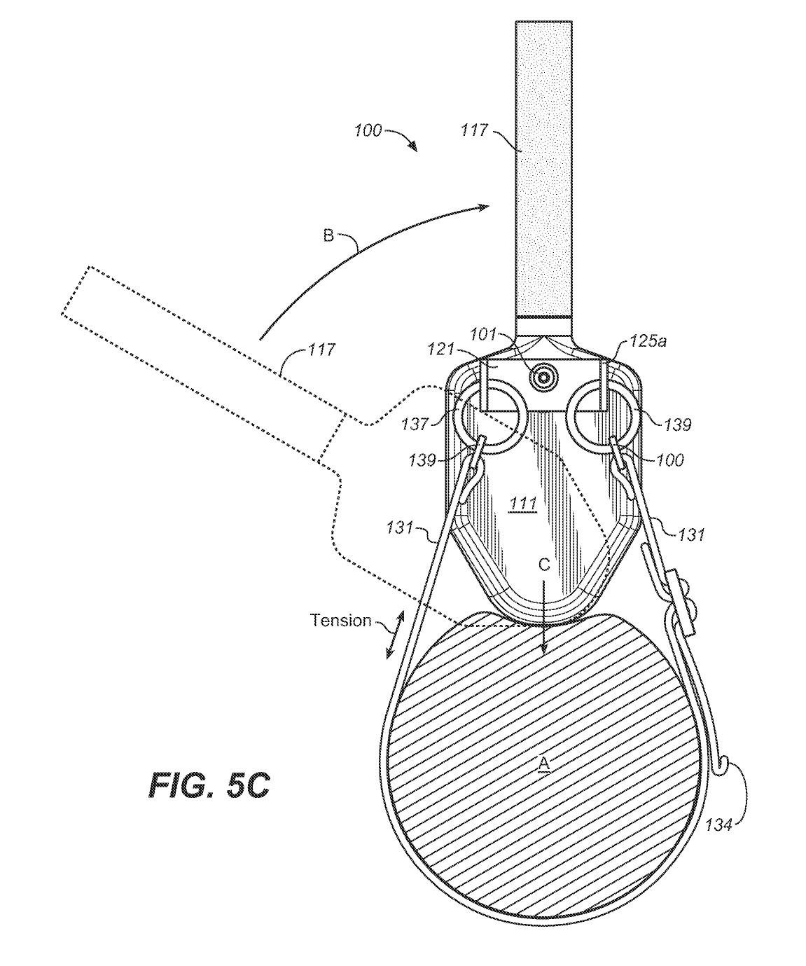

A method of the use of device 100 is illustrated in FIGS. 5A, 5B, and 5C, which are front views of the device an appendage A of the user, where FIG. 5A illustrates the positioning of the device on the user; FIG. 5B illustrates the tightening of the device on the user; and FIG. 5C illustrates the user of the device is massaging the user.

A first step of the method is to encircle strap 131 and body 110 about the user's appendage. Thus, for example and without limitation, FIG. 5A shows that a user may open the length of strap 131, as necessary, and place strap about an appendage A, such as an arm or a leg.

In another embodiment, the step of FIG. 5A may include first removing the end 134 of strap 131 from the buckle 136, placing the strap over the appendage, and then inserting the end into the buckle.

As is shown in FIG. 5B, flange 113 is then placed against appendage A, and end 134 of strap 131 is pulled to tighten restraining portion 130, thus forcing the flange against the appendage. Thus, for example, end 134 is pulled until curved surface 119 is snugly held against appendage A.

Next, as shown in FIG. 5C, the user may move handle 117, as shown by arrow B, causing the flange to contact and compress appendage A. Thus, for example, with no slippage of strap 131 or flange 113 on appendage A, the movement B of handle 117 rotates device 100 and results in a compressive force C on the appendage. It is preferred that it is the curved surface 119 of flange 113 that contacts appendage A, thus providing greater leverage of the applied force. The user may also rock handle 117 back and forth to adjust the compressive force C.

When the user is done massaging, the steps of FIGS. 5A-5C may be reversed and device 100 may be taken off of appendage A.

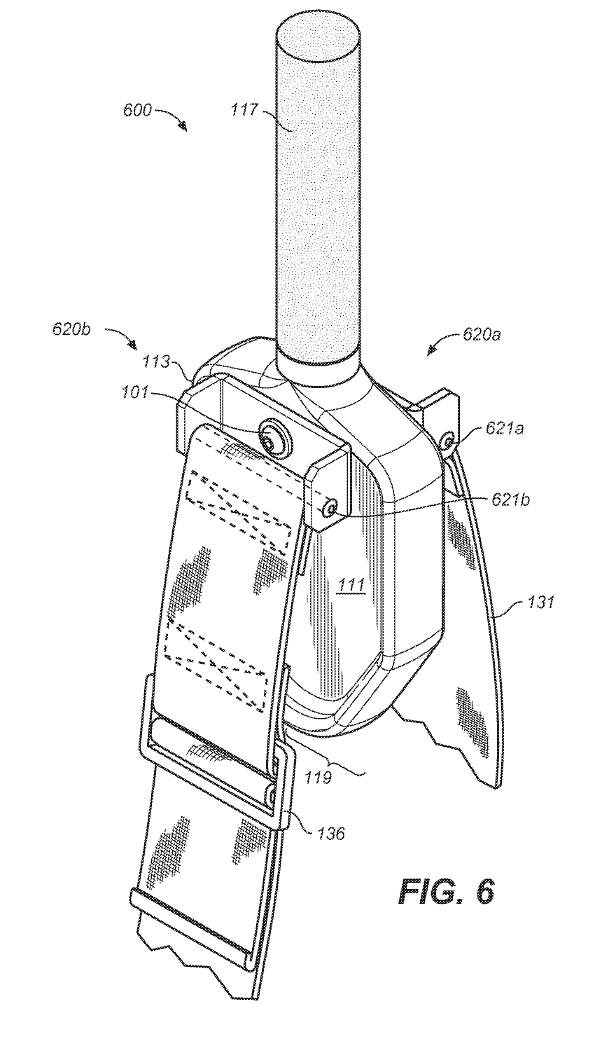

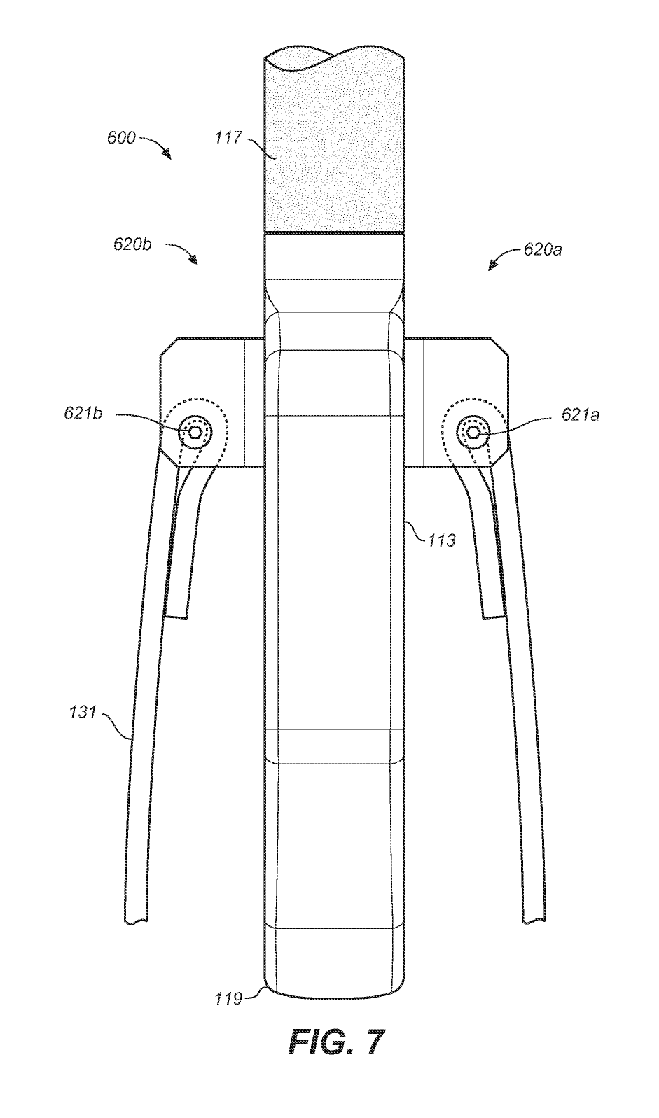

FIGS. 6 and 7 are a back, side perspective view, and a side view, respectively of a second embodiment device 600 for massaging. Device 600 is generally similar to device 100, except as explicitly stated.

Device 600 of FIGS. 6 and 7 includes a pair of brackets 620a and 620b which support pins 621a and 621b, respectively. Pins 621a and 621b support belt 130, which includes a buckle 136 for adjusting the length of the belt. The operation of device 600 is similar to that of device 100, where a user places a body part between belt 130 and curved surface 119.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

I claim:

1. A method for massaging a user with a device that includes a handle, body including a surface, a strap, and a mechanism for adjusting the length of the strap, said method comprising:
placing the user between the body of the device and the strap, such that the strap and the body of the device surrounds the user;
adjusting the length of the strip such that the surface is held against the user; and
moving the handle to increase the force of the surface on the user.

2. The method of claim 1, wherein
said placing includes inserting the user between the body of the device and the strap.

3. The method of claim 1, wherein
said mechanism includes a buckle for accepting an end of the strap, and wherein
said placing includes:
removing the end of the strap from the buckle,
positioning the body of the device on the user;
placing the strap over the user, and
inserting the end of the strap into the buckle.

4. The method of claim 1, wherein said adjusting includes positioning the surface against the user.

5. The method of claim 1, wherein:
said mechanism includes a buckle for accepting an end of the strap, and wherein
said adjusting includes pulling the end of the strap to tighten the strap and surface against the user.

6. The method of claim 1, wherein said moving includes moving the position at which the surface contacts the user.

7. The method of claim 1, wherein said moving moves said surface in the plane perpendicular to axis of the user.

8. A method for massaging a user with a device that includes a handle, a body including a surface, a strap, and a mechanism for adjusting the length of the strap, said method comprising:
inserting the user between the surface and the strap, such that the strap and surface surrounds the user;
pulling the end of the strap to tighten the strap and surface against the user; and
moving the handle in a plane perpendicular to the user, such that the force on the user is adjusted.

9. The method of claim 8, wherein
said mechanism includes a buckle for accepting an end of the strap, and wherein
said pulling includes:
removing the end of the strap from the buckle,
positioning the body of the device on the user;
placing the strap over the user, and
inserting the end of the strap into the buckle.

10. The method of claim 8, wherein said pulling includes positioning the surface against the user.

12. The method of claim 8, wherein said moving includes moving the position at which the surface contacts the user.

13. The method of claim 8, wherein said moving moves said surface in the plane perpendicular to axis of the user.
